(19) United States
(12) Patent Application Publication
(10) Pub. No.: US 2007/0067110 A1
(43) Pub. Date: Mar. 22, 2007

(54) Generation of negative controls for arrays

(76) Inventors: Charles F. Nelson III, San Carlos, CA (US); Nicholas M. Sampas, San Jose, CA (US); Bo U. Curry, Redwood City, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/232,817

(22) Filed: Sep. 21, 2005

(51) Int. Cl. G06F 19/00

(52) U.S. Cl. 702/20

(57) ABSTRACT

The invention relates to methods and systems for generating negative controls for arrays. In an embodiment, the invention includes a method for generating a negative control probe sequence for an array including randomly generating a plurality of candidate negative control probes, screening the candidate negative control probes for sequence similarity to biologically occurring sequences, and screening the candidate negative control probes for one or more of base composition properties, primary structural features, secondary structural features, or thermodynamic characteristics. In an embodiment, the invention includes an apparatus for generating a negative control sequence for an array. The apparatus including a memory store and a programmable circuit in electrical communication with the memory store, the programmable circuit programmed to randomly generate a plurality of candidate probe sequences, screen the candidate probe sequences for sequence similarity to biologically occurring sequences, and screen the candidate probe sequences for one or more of base composition properties, primary structural features, secondary structural features, or thermodynamic characteristics.

### BACKGROUND

Array technologies have gained prominence in biological research and serve as valuable diagnostic tools in the healthcare industry. A fundamental principle upon which arrays are based is that of specific recognition. Probe molecules affixed to the array can specifically recognize and bind target molecules, either by sequence-mediated binding affinities, binding affinities based on conformational or topological properties of probe and target molecules, or binding affinities based on spatial distribution of electrical charge on the surfaces of target and probe molecules.

An array generally includes a substrate upon which a regular pattern of features is prepared by various manufacturing processes. The array typically has a grid-like two-dimensional pattern of features. For nucleic acid arrays, each feature of the array contains a large number of oligonucleotides covalently bound to the surface of the feature. These bound oligonucleotides are known as probes. In general, chemically distinct probes are bound to the different features of an array, so that each feature corresponds to a particular nucleotide sequence.

Once an array has been prepared, the array may be exposed to a sample solution containing target molecules (such as DNA or RNA) labeled with fluorophores, chemiluminescent compounds, or radioactive atoms. The labeled target molecules then hybridize to the complementary probe molecules, synthesized on the surface of the array. Targets, such as labeled DNA molecules, that are not complementary to any of the probes bound to array surface do not hybridize as readily and tend to remain in solution. The sample solution is then rinsed from the surface of the array, washing away any unbound labeled molecules. Finally, the bound labeled molecules are detected via optical or radiometric scanning.

Scanning of an array by an optical scanning device or radiometric scanning device generally produces a scanned image comprising a rectilinear grid of pixels, with each pixel having a corresponding signal intensity. Typically, an array-data-processing program then manipulates these signal intensities and produces experimental or diagnostic results.

Results from array systems frequently include at least some amount of background noise. This background noise can be caused by various factors including non-specific binding between probe molecules and labeled target molecules as well as contamination of the array. Accordingly, the measured signal intensity of features on the array must generally be corrected for measured background noise. One approach to measuring background noise is to place negative control features on the array and then measure the negative control signal levels. One technique for creating negative controls is to use probes having a secondary structure that prevents hybridization of the control with any labeled targets (“structural negative controls”). However, structural negative controls are not biologically available because they don't have the potential to bind with labeled targets, regardless of sequence. Another technique for creating negative controls is to use probes that are derived from organisms evolutionarily distinct from the target sample organism. However, negative control probes produced by this approach cannot be used without knowledge of the target sample organism at the time the array is constructed.

### SUMMARY

In general terms, the present invention relates to generating and screening probe sequences for negative controls for arrays.

One aspect is a method for generating a negative control probe sequence for an array. The method comprising randomly generating a plurality of candidate negative control probes, screening the candidate negative control probes for sequence similarity to biologically occurring sequences, and screening the candidate negative control probes for one or more of base composition properties, primary structural features, secondary structural features, or thermodynamic characteristics.

Another aspect is a computer-readable medium having computer-executable instructions for generating a negative control probe sequence for an array.

Another aspect is an apparatus for generating a negative control sequence for an array. The apparatus comprises a memory store and a programmable circuit in electrical communication with the memory store. The programmable circuit can be programmed to randomly generate a plurality of candidate probe sequences, screen the candidate probe sequences for sequence similarity to biologically occurring sequences, and screen the candidate probe sequences for one or more of base composition properties, primary structural features, secondary structural features, or thermodynamic characteristics.

Another aspect is an isolated nucleotide sequence comprising the sequence of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, or SEQ ID NO: 13.

### BRIEF DESCRIPTION OF THE DRAWINGS

Embodiments may be more completely understood in connection with the following drawings, in which:

FIG. 1 illustrates a schematic diagram of a system for manufacturing arrays.

FIG. 2 illustrates an example general purpose computing system.

FIG. 3 shows operations in an embodiment of a method.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Embodiments of the invention can be used to generate negative control probe sequences. The term “negative control probe sequence” as used herein shall refer to a sequence of bases that can be deposited on an array and serve as a negative control during use of the array.

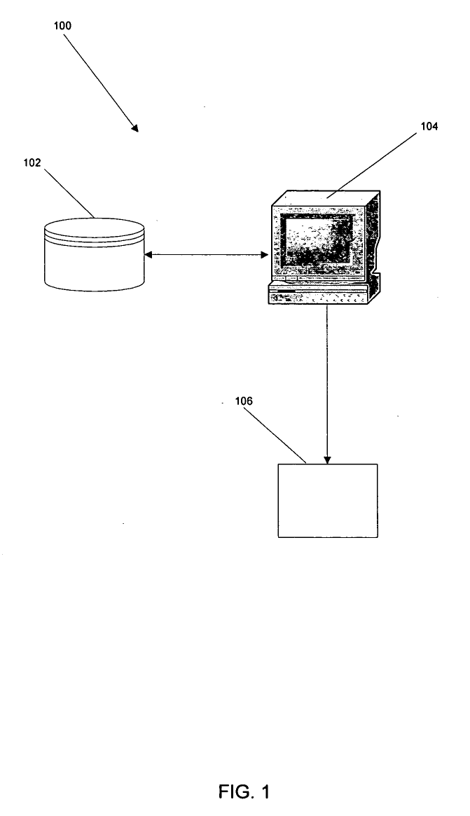

Referring now to FIG. 1, a schematic diagram of an exemplary system 100 for manufacturing arrays is shown. A computing system 104 is in electronic communication with a database 102 and an array printer 106. In an embodiment, the computing system 104 directs the operations of the array printer 106. It will be appreciated that in some embodiments the computing system 104 is part of the array printer 106. However, in other exemplary embodiments, the computing system 104 and the array printer 106 are separate. In addition, it will be appreciated that in some embodiments the database 102 is part of the computing system 104. However, in other exemplary embodiments, the database 102 and the computing system 104 are separate. The computing system 104 can query the database 102 as desired to retrieve data on probe sequences or on known biological sequences.

The array printer 106 can perform various steps to deposit features onto the array substrate. Exemplary array manufacturing machines and methods are described in U.S. Pat. No. 6,900,048 (Perbost et al.); U.S. Pat. No. 6,890,760 (Webb); U.S. Pat. No. 6,884,580 (Caren et al.); and U.S. Pat. No. 6,372,483 (Schleifer et al.). Descriptions of array manufacturing methods and equipment and definitions regarding the same found in Perbost et al., Webb, Caren et al., and Schleifer et al. are herein incorporated by reference, while other aspects, such as prosecution histories, are not incorporated as part of the present application. In some embodiments, the array printer 106 uses inkjet technology. In an embodiment, the array printer 106 prints spots of pre-synthesized nucleotide sequences onto the array substrate. In an embodiment, the array printer 106 can be used for in situ fabrication, where nucleotide sequences are built on the array one base at a time. Embodiments of the array printer 106 can also include those that use photolithographic methods to deposit nucleotide sequences onto the array substrates.

Some embodiments of methods described herein are implemented as logical operations in a computing system, such as the computing system 104. The logical operations can be implemented (1) as a sequence of computer implemented steps or program modules running on a computer system and (2) as interconnected logic or hardware modules running within the computing system. This implementation is a matter of choice dependent on the performance requirements of the specific computing system. Accordingly, the logical operations making up the embodiments described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto. This software, firmware, or similar sequence of computer instructions may be encoded and stored upon computer readable storage medium.

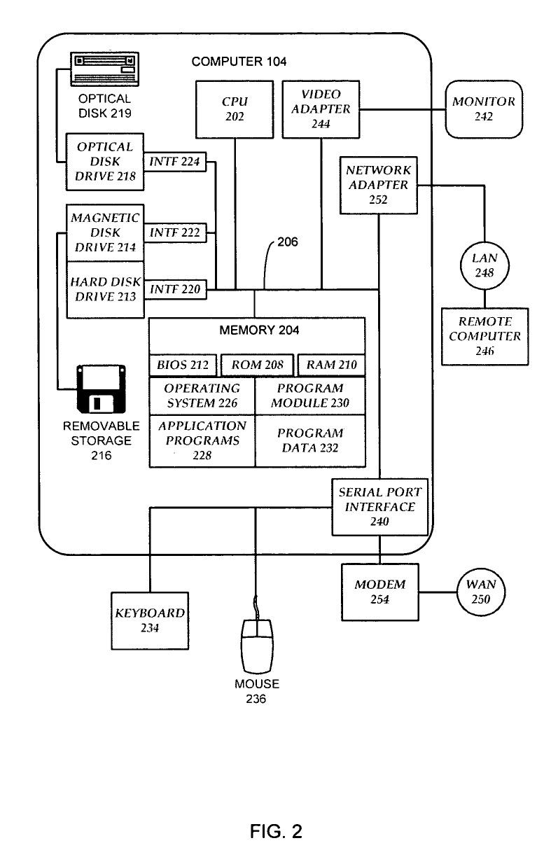

Referring now to FIG. 2, an example computing system 104 is illustrated. The computing system 104 illustrated in FIG. 2 can take a variety of forms such as, for example, a mainframe, a desktop computer, a laptop computer, a hand-held computer, or any other programmable device. In addition, although computing system 104 is illustrated, the systems and methods disclosed herein can be implemented in various alternative computer systems as well.

The computing system 104 includes a processor unit 202, a system memory 204, and a system bus 206 that couples various system components including the system memory 204 to the processor unit 202. The system bus 206 can be any of several types of bus structures including a memory bus, a peripheral bus and a local bus using any of a variety of bus architectures. The system memory includes read only memory (ROM) 208 and random access memory (RAM) 210. A basic input/output system 212 (BIOS), which contains basic routines that help transfer information between elements within the computing system 104, is stored in ROM 208.

The computing system 104 further includes a hard disk drive 213 for reading from and writing to a hard disk, a magnetic disk drive 214 for reading from or writing to a removable magnetic disk 216, and an optical disk drive 218 for reading from or writing to a removable optical disk 219 such as a CD ROM, DVD, or other optical media. The hard disk drive 213, magnetic disk drive 214, and optical disk drive 218 are connected to the system bus 206 by a hard disk drive interface 220, a magnetic disk drive interface 222, and an optical drive interface 224, respectively. The drives and their associated computer-readable media provide nonvolatile storage of computer readable instructions, data structures, programs, and other data for the computing system 104.

Although the example environment described herein can employ a hard disk 213, a removable magnetic disk 216, and a removable optical disk 219, other types of computer-readable media capable of storing data can be used in the example system 104. Examples of these other types of computer-readable mediums that can be used in the example operating environment include magnetic cassettes, flash memory cards, digital video disks, Bernoulli cartridges, random access memories (RAMs), and read only memories (ROMs).

A number of program modules can be stored on the hard disk 213, magnetic disk 216, optical disk 219, ROM 208, or RAM 210, including an operating system 226, one or more application programs 228, other program modules 230, and program data 232.

A user may enter commands and information into the computing system 104 through input devices such as, for example, a keyboard 234, mouse 236, or other pointing device. These and other input devices are often connected to the processing unit 202 through a serial port interface 240 that is coupled to the system bus 206. Nevertheless, these input devices also may be connected by other interfaces, such as a parallel port, game port, or a universal serial bus (USB). An LCD display 242 or other type of display device is also connected to the system bus 206 via an interface, such as a video adapter 244.

The computer system 104 may operate in a networked environment using logical connections to one or more remote computers, such as a remote computer 246. The remote computer 246 may be a computer system, a server, a router, a network PC, a peer device or other common network node, and typically includes many or all of the elements described above relative to the computer system 104. The network connections can include a local area network (LAN) 248 and a wide area network (WAN) 250. When used in a LAN networking environment, the computer system 104 is connected to the local network 248 through a network interface or adapter 252. When used in a WAN networking environment, the computing system 104 typically includes a modem 254 or other means for establishing communications over the wide area network 250, such as the Internet. In a networked environment, program modules depicted relative to the computing system 104, or portions thereof, may be stored in the remote memory storage device. It will be appreciated that the network connections shown are examples and other means of establishing a communications link between the computers may be used.

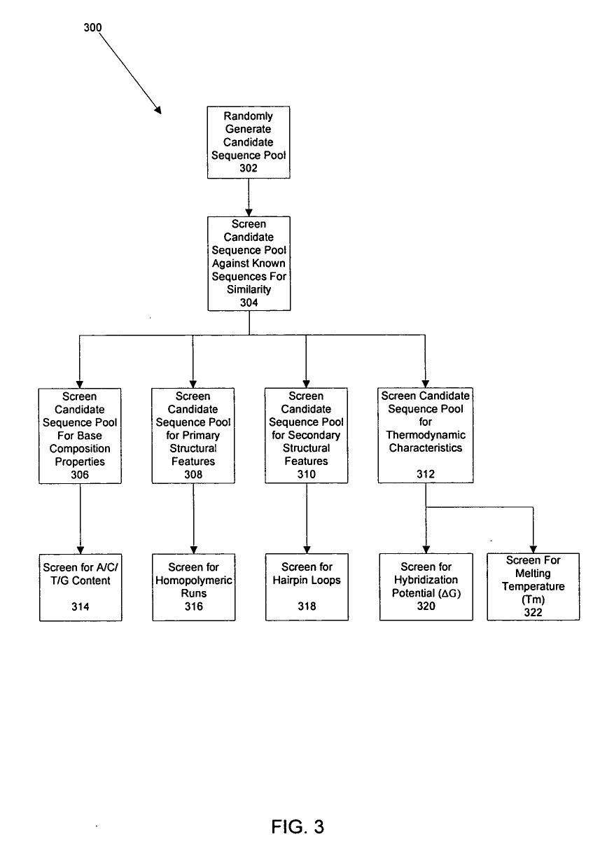

Referring to FIG. 3, a flowchart 300 is provided illustrating operations that are performed in some embodiments. First, a pool of candidate sequences are randomly generated 302. These candidate sequences can be generated in many ways described in more detail below. The candidate sequences are screened against known biological sequences to eliminate those having sequence similarity with any biological sequence 304. The term “sequence similarity” as used herein shall refer to the degree to which two sequences are similar in their base sequence. Sequence similarity can be quantitated in various ways known to those of skill in the art. The candidate sequences can be screened for various sequence properties. In some embodiments, the candidate sequences are screened for one or more of base composition properties 306, primary structural features 308, secondary structural features 310, or thermodynamic characteristics 312.

The term “base composition properties” shall refer to properties of a sequence related to base composition. By way of example, while not limiting the term, base composition properties can include the percentage of A, C, T, and G sequences within a given probe sequence.

The term “primary structural features” as used herein shall refer to structural features of a sequence related the contiguous positioning of bases in the sequence. While not limiting the term, an example of a primary structural feature is a homopolymeric run.

The term “homopolymeric run” as used herein shall refer to a portion of a base sequence wherein a given base is repeated more than once. By way of example, a sequence contains the contiguous bases “TTTTT” would be considered to have a homopolymeric run.

The term “secondary structural features” as used herein shall refer to structural features (predicted or empirical) of a sequence caused by the interaction between both contiguous and non-contiguous bases in the sequence. While not limiting the term, an example of a secondary structural feature is a hairpin loop structure.

As used herein, the term “thermodynamic characteristics” shall refer to characteristics of a sequence described in thermodynamic terms. By way of example, while not limiting the term, thermodynamic characteristics of a given sequence can include the Gibbs free energy of hybridization of that sequence with another sequence. As a further example, while not limiting the term, thermodynamic characteristics of a given sequence can include the melting temperature (Tm) of the sequence.

As shown in FIG. 3, screening the candidate sequences for base composition properties 306 can include screening for A/C/T/G content 314. Screening the candidate sequences for primary structural features 308 can include screening for homopolymeric runs 316. Screening the candidate sequences for secondary structural features 310 can include screening for hairpin loops 318. Screening the candidate sequences for thermodynamic characteristics 312 can include screening the candidate sequences for hybridization potential against known biological sequences 320. Screening the candidate sequences for thermodynamic characteristics 312 can also include screening the candidate sequences for melting temperature 322. Individual screening operations are performed by themselves or in addition to other screening operations. In general, each screening operation reduces the pool of potential candidate sequences. After all screening operations in a particular embodiment are performed, the remaining pool of candidate sequences can be referred to as “finalist sequences.”

Embodiments of arrays include any one, two or three-dimensional arrangement of addressable regions bearing a particular chemical moiety or moieties (for example, biopolymers such as nucleotide sequences) associated with that region. Exemplary arrays are addressable in that they have multiple regions of different moieties (for example, different nucleotide sequences) such that a region (a feature or spot of the array) at a particular predetermined location (an address) on the array will detect a particular target or class of targets (although a feature may incidentally detect non-targets of that feature). Targets are referenced as a moiety in a mobile phase (typically fluid), to be detected by probes (target probes) which are bound to the substrate at the various regions. Operations performed in some embodiments will now be discussed in greater detail.

Some embodiments include randomly generating candidate negative control probes. As used herein, the term “random” shall include pseudo-random unless indicated to the contrary. It will be appreciated that there are many techniques for generating random sequences. By way of example, U.S. Pat. No. 4,691,291 (Wolfram) discloses methods of generating random sequences. Other techniques include lottery methods, the use of random number tables, entropy approaches, and the like. It will also be appreciated that there are many ways of using computer systems to automatically generated random sequences. Further, techniques for generating random sequences can be implemented in many different programming languages. An example of a random sequence generation script for the PERL language is included in Example 1 below.

In an embodiment, the candidate negative control probes are sequences represented by the letters (A/T/G/C). It will be appreciated that these letters correspond to the bases occurring in DNA. However, in some embodiments, other letters are used corresponding to components of other biopolymers, such as RNA or polypeptides. In addition, in some embodiments, letters are used corresponding to artificial components such as non-naturally occurring nucleotides or peptides. As used herein the term “bases” or “monomer units” or “letters” may be used interchangeably though in specific contexts as will be apparent, the term “bases” or “monomer units” will refer to the chemical moieties, while “letters” will refer to a representation of the former.

The candidate negative control probes can have any desired length. However, very short sequences, for example a sequence with 1 to 4 monomer units (e.g., bases, represented by 1 to 4 letters), would be expected to result in many matches with known biologically occurring sequences. Therefore, the length of the candidate negative controls should be sufficient to reduce the number of matches found among known biologically occurring sequences. In an embodiment, the length of the candidate negative controls is greater than 4 bases (or letters). Very long sequences may result in tedious computational analysis and be unnecessary for providing a suitable negative control. In an embodiment, the candidate negative control sequences are less than 150 bases (or letters) in length. In an embodiment, the candidate negative control sequences are from 5 to 150 bases in length. In an embodiment, the candidate negative control sequences have a length that is equal to the length of the target probes that are deposited on the same array. In an embodiment, the candidate negative control sequences are 60 bases (or letters) in length.

The total number of possible unique random candidate sequences generated depends on the number of unique values a given position can have and the total length of the sequence. For example, in the case of using A/T/G/C as the letters and a total length of 60, there are 1.33×10³⁶ different possible combinations that can be generated randomly. It is estimated that only a small fraction of these randomly generated sequences are found within transcripts produced by all living organisms. Of course, as the length of the randomly generated sequence decreases, the fraction that could be found within transcripts produced by living organisms would be expected to increase. However, for any given length of random sequence generated, those that are found within the transcripts produced by living organisms can be removed from the candidate pool through similarity screening in silico as described further below and/or by empirical testing (e.g., in a hybridization experiment).

In some embodiments, candidate negative controls that have sequences similar to naturally occurring sequences are removed from the pool of candidates by similarity screening. Similarity screening can be performed using many different tools available to those of skill in the art. A possible example includes determining similarity using the BLASTN program available at the website for the National Center for Biotechnology Information (NCBI) (ncbi.nih.gov/BLAST/). The BLASTN program uses the heuristic search algorithm BLAST (Basic Local Alignment Search Tool) to compare a nucleotide sequence (N) against a nucleotide sequence dataset. See Altschul et al., 1990, J. Mol. Biol., 215:403-10. The BLAST algorithm identifies regions of local similarity and then moves bi-directionally until the BLAST score declines. Segment pairs whose scores cannot be improved by extension or trimming are referred to as high-scoring segment pairs or HSPs.

HSP size thresholds can be effectively set in various ways. For example, one way is by setting the “word size” in the BLAST search. Word size can be set to any desired number of bases. In some embodiments, the word size is between 5 and 20 bases. In some embodiments, the word size is set as 7 bases. A search with this word size would then yield HSPs with a minimum size of 7 contiguous bases with 100% match. In an embodiment, the word size is set as 11 bases. In an embodiment, the word size is set as 15 bases.

Candidate probe sequences that have significant similarity to naturally occurring sequences are undesirable for use as negative controls. In some embodiments, a BLAST raw score (S) is used to select those sequences that do not have significant similarity to known biological sequences. It will be appreciated that BLAST raw score thresholds can be set as desired. In an embodiment, candidate negative control sequences producing any matches against biological sequences with a BLAST raw score of greater than or equal to about 20 are not used. In an embodiment, candidate negative control sequences producing any matches against biological sequences with a BLAST raw score of greater than or equal to about 25 are not used. In an embodiment, candidate negative control sequences producing any matches against biological sequences with a BLAST raw score of greater than or equal to about 30 are not used. In an embodiment, candidate negative control sequences producing any matches against biological sequences with a BLAST raw score of greater than or equal to about 30.23 are not used.

In some embodiments, the candidate probes are screened based on their base composition properties. It will be appreciated that there are many different techniques for base composition property screening. Base composition property screening, in some embodiments, includes characterizing the percentages of different bases in the candidate sequences. For example, a candidate sequence with a length of 60 bases including 17A, 16C, 13T, 14G, would have a A/C/T/G % of 28.3% A/26.6% C/21.6% T/23.3% G. In some embodiments, candidate sequences are selected that have percentages of different bases that are approximately equal to the percentages of different bases in the target probes. In some embodiments, candidate sequences are selected having percentages of different bases that are within +/−5% of the total percentages of different bases across all of the target probes included in a given array.

In some embodiments, the candidate probes are screened for primary structural features. For example, in some embodiments, the candidate sequences are profiled for homopolymeric runs. Homopolymeric runs may be undesirable in negative control probe sequences because of non-specific hybridization risks. Therefore, in an embodiment, candidate sequences having significant homopolymeric runs are discarded. In an embodiment, candidate sequences having homopolymeric runs equal to or greater than four bases in length are discarded. In an embodiment, candidate sequences having homopolymeric runs equal to or greater than five bases in length are discarded. In an embodiment, candidate sequences having homopolymeric runs equal to or greater than six bases in length are discarded.

Base sequences can assume various secondary structural features based on attractive and repulsive forces between both contiguous and non-contiguous bases. In an embodiment, the candidate probe sequences are screened for secondary structure. It will be appreciated that there are many different algorithms known to those of skill in the art that allow the calculation of probable secondary structure based on sequence. Examples of such algorithms are described in Zuker and Stiegler, 1981, Nucl. Acids Res., 9:133-148 (embodied in mfold, available at The Bioinformatics Center at Rensselaer and Wadsworth website) (bioinfo.rpi.edu/applications/mfold/); Wuchty et al., 1999, Biopolymers, 49(2): 145-65; and McCaskill, 1990, Biopolymers, 29:1105-1119. Many such algorithms function by searching for optimal energetic configurations. Some predictive algorithms also take into account the effects that temperature would have on probably secondary structure. In some embodiments, secondary structure is predicted at a plurality of temperatures. In an embodiment, secondary structure is predicted at 27° C. and 66° C.

Some types of secondary structural features may alter the ability of the candidate sequence to hybridize with sample target sequences. By way of example, depending on the sequence of bases, a hairpin-loop structure could be formed by the base sequence. Hairpin-loops may have the effect of structurally preventing hybridization. In effect, if incorporated into a negative control, hairpin loop structures can cause the negative control to function more like a structural negative control, as described above, and therefore prevent the negative control from being biologically available. The term “biologically available” as used herein with reference to negative control probe sequences shall refer to a probe sequence having the structural potential to hybridize with another sequence. Biologically available probes stand in contrast to probes that have no potential or extremely limited potential of hybridizing to other sequences under normal testing conditions due to factors such as structural configuration (e.g., the sequence contains hairpin loops, etc.). In an embodiment, candidate sequences having secondary structural features that render the candidate biologically unavailable are discarded. In an embodiment, candidate sequences predicted to form a hairpin loop structure under physiological conditions are discarded.

In some embodiments, the candidate probes are screened by their thermodynamic characteristics. It will be appreciated that thermodynamic characteristic screening can include many different techniques. Some embodiments of thermodynamic characteristic screening include screening for hybridization potential against known biological sequences. Where the hybridization potential between a candidate sequence and a non-identical known biological sequence is too great, cross-hybridization can occur. Cross-hybridization refers to the formation of lower affinity mismatched duplexes involving sequences other than the intended target. An array with significant cross-hybridization may have reduced ability to detect low abundance target sequence species and therefore a reduced ability to discriminate closely related target species. The degree of cross-hybridization that can occur may be influenced by many factors including hybridization temperature, time allowed for hybridization, concentration of target molecules in the sample solution, ionic concentrations, etc.

In an embodiment, methods include screening the candidate sequences against known biological sequences for hybridization potential. Hybridization potentials can be calculated using various algorithms known to those of skill in the art. By way of example, hybridization potentials for given sequences can be calculated using a program such as available online at The Bioinformatics Center at Rensselaer and Wadsworth website (bioinfo.rpi.edu/applications).

One manner of expressing hybridization potential is as AG (change in Gibbs free energy) in units of kcals/mol. In an embodiment, candidate sequences having hybridization potential with any naturally occurring biological sequence of a magnitude greater than or equal to −5 kcal/mol are discarded. In an embodiment, candidate sequences having hybridization potential with any naturally occurring biological sequence of a magnitude greater than or equal to −10 kcal/mol are discarded. In an embodiment, candidate sequences having hybridization potential with any naturally occurring biological sequence of a magnitude greater than or equal to −15 kcal/mol are discarded.

In an embodiment, thermodynamic screening includes calculating the melting temperature (Tm) of candidate sequences. In the denaturation of DNA, melting temperature is taken as the midpoint of the helix-to-coil transition. It will be appreciated that there are many different algorithms known to those of skill in the art that allow the prediction of melting temperature based on primary structure (the sequence itself). See, e.g., Dimitrov and Zuker, 2004, Biophysical Journal, 87:215-226. The higher the melting temperature, the more energetically stable the duplex or hybridization is.

If incorporated into a negative control, sequences with a melting temperature that is too low may result in a negative control that is not “biologically available” in the sense that even if a specific binding partner were present in the sample, such a sample sequence would be removed during wash steps. Therefore, in an embodiment, candidate sequences having a predicted melting temperature of less than a defined amount are discarded. In an embodiment, candidate sequences having a predicted melting temperature of less than about 60° C., assuming molecule concentrations of between about 1×10⁻⁸ M and 1×10⁻¹² M and a length of 60 bases, are discarded. In an embodiment, candidate sequences having a predicted melting temperature of less than about 70° C., assuming molecule concentrations of between about 1×10⁻⁸ M and 1×10⁻¹² M and a length of 60 bases, are discarded.

It can be desirable to incorporate negative controls probes with a predicted melting temperature in the same range as the target probes on the array. In an embodiment, candidate sequences having a predicted melting temperature of greater than a defined amount are discarded. In an embodiment, candidate sequences having a predicted melting temperature of greater than about 105° C., assuming molecule concentrations of between about 1×10⁻⁸ M and 1×10⁻¹² M and a length of 60 bases, are discarded. In an embodiment, candidate sequences having a predicted melting temperature of greater than about 95° C., assuming molecule concentrations of between about 1×10⁻⁸ M and 1×10⁻¹² M and a length of 60 bases, are discarded. It will be appreciated that melting temperature is dependent on factors including sequence length. Accordingly, specific melting temperatures used as cut-offs for screening purposes can vary with different sequence lengths.

Some embodiments include screening techniques that rely on dataset(s) containing known biological sequences. Many projects being conducted by those of skill in the art continue to add to the total pool of known biological sequences. Typically, newly discovered sequences are added to various datasets (databases) redundantly or non-redundantly. Exemplary databases containing known biological sequences include the NCBI nt database (ncbi.nih.gov), the TIGR (The Institute for Genomic Research) gene indices (tigr.org/tdb/tgi/index.shtml), and the NCBI's Unigene datasets (ncbi.nlm.nih.gov/entrez/query.fcgi?db=unigene). In some embodiments, screening techniques are performed against one or more of the NCBI nt dataset, the TIGR gene indices, and the NCBI's Unigene unique datasets for H. sapiens, A. thaliana, and C. elegans.

Those of skill in the art will appreciate that there are also other databases that are available and that contain additional sequences from many different organisms. Publicly available sequence databases include those maintained by: GenBank (Bethesda, Md. USA) (ncbi.nih.gov/genbank/), European Molecular Biology Laboratory's European Bioinformatics Institute (EMBL-Bank in Hinxton, UK) (ebi.ac.uk/embl/), the DNA Data Bank of Japan (Mishima, Japan) (ddbj.nig.acjp/), the Ensembl project (ensembl.org/index.html), and The Institute for Genomic Research (TIGR) (tigr.org). Examples of databases that can be obtained and/or searched through the NCBI web portal (ncbi.nih.gov) include Entrez Nucleotides (including data from GenBank, RefSeq, and PDB), all divisions of GenBank, RefSeq (nucleotides), dbEST, dbGSS, dbMHC, dbSNP, dbSTS, TPA, UniSTS, PopSet, UniVec, WGS, Entrez Protein (including data from SwissProt, PIR, PRF, PDB, and translations from annotated coding regions in GenBank and RefSeq), RefSeq (proteins), and many others. It will be appreciated that some datasets are directed to certain types of sequence information. By way of example, some datasets are directed to genomic nucleotide sequences, while other datasets are directed to expressed nucleotide sequences. Still other datasets are directed to polypeptide sequences.

Some embodiments include screening candidate sequences against databases of known sequences for similarity and/or various thermodynamic properties such as hybridization potentials using a computer system. Many publicly available databases can be accessed with computer programs in a way that facilitates automated screening of candidate sequences. Some embodiments include a computer program that automatically screens candidate sequences against databases of known sequences.

Any given array substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm² or even less than 10 cm². Interfeature areas are present in some embodiments that do not carry any polynucleotides (or other biopolymer of a type of which the features are composed). Such interfeature areas typically will be present where the arrays are formed by processes involving drop deposition of reagents but may not be present when, for example, photolithographic array fabrication processes are used. It will be appreciated that the interfeature areas, when present, could be of various sizes and configurations.

With arrays that are read by detecting fluorescence, the substrate may be of a material that emits low fluorescence upon illumination with the excitation light. Additionally, the substrate may be relatively transparent to reduce the absorption of the incident illuminating laser light and subsequent heating if the focused laser beam travels too slowly over a region.

Embodiments may be better understood with reference to the following examples. These examples are intended to be representative of specific embodiments but are not intended as limiting the scope.

### EXAMPLES

### Example 1

### Generation of Random Sequences

While it will be appreciated that there are many different techniques for generating random sequences, this example provides a PERL script as a specific example. This code uses a time/date stamp for purposes of random seeding, although many other random seeding techniques could also be used.

```
use strict;
use warnings;
if (scalar(@ARGV) == 0) {
  print <<EOS;
Usage: $0 -S [# of sequences] -min [shortest seq.]
-max [longest seq.]
EOS
  exit;
}
my $size_of_set = 0;
my $maximum_length = 0;
my $minimum length = 0;
my @random_DNA = ( );
my $init = 0;
my $title = 0;
my $i = 0;
my $printSeq = 0;
for($i = 0;$i < @ARGV;$i++)
{
```

if($ARGV[$i] =˜/-S/)
{

$size_of_set = $ARGV[$i+1];

}
if($ARGV[$i] =˜ /-min/)
{

$minimum_length = $ARGV[$i+1];

}
if($ARGV[$i]=˜/-max/)
{

$maximum_length = $ARGV[$i+1];

}

}
srand (time|$$);
@random_DNA = make_random_DNA_set
($minimum_length,
$maximum_length, $size_of_set);
foreach my $dna (@random_DNA) {

$title = $init++;
print “>Sequence_$title\n”;
formatFASTA($dna, 50);

| } | |
|---|---|
| print “\n”; | |
| exit; | |
| ################################################# | |
| # Subroutines | # |

#################################################
#createRamdom_set################################
sub make_random_DNA_set {

my($minimum_length, $maximum_length,
$size_of_set) = @_;
my $length;
my $dna;
my @set;
for (my $i = 0; $i < $size_of_set; ++$i) {

$length = randomlength ($minimum_length,
$maximum_length);
$dna = make_random_DNA ($length);
push(@set, $dna);

}
return @set;

}
#randomlength####################################
sub randomlength {

my ($maxlength, $minlength) = @_;
return (int(rand($maxlength − $minlength +1)) +
$minlength);

}
#make_random_DNA#################################
sub make_random_DNA {

my ($length) = @_;
my $dna;
for (my $i = 0; $i <$length ; ++$i) {
$dna .= randomnucleotide( );
}
return $dna;

}
#randomnucleotide################################
sub randomnucleotide {

my(@nucleotides)=(‘A’, ‘C’, ‘G’, ‘T’);
return randomelement(@nucleotides);

}
#randomelement###############################
sub randomelement {

my(@array) = @_;
return $array[rand @array];

}
#formatFASTA#####################################
sub formatFASTA {

my ($sequence, $length) = @_;
for (my $pos = 0; $pos <length ($sequence); $pos +=
$length) {

print substr($sequence, $pos, $length), “\n”;

}

}

### Example 2

### Candidate Sequence Screening

The code in Example 1 was used to generate approximately 1.4 million candidate sequences, forming an initial candidate sequence pool. This pool of candidate sequences was then screened for similarity against known biological sequences. Specifically, similarity against sequences including those from the NCBI Unigene Unique datasets for H. sapiens, C. elegans, and A. thaliana; the NCBI nt dataset; and the TIGR ALL_TGI dataset was determined using the BLAST algorithm, with a word size of 15 (without filters such as the low-complexity filter). Candidate sequences having a Raw Score (S) of at least 30.23 were then discarded from the candidate pool.

The pool of sequences remaining after similarity screening was then screened for primary structure such as homopolymeric runs. Candidate sequences having homopolymeric runs of greater than 5 bases were discarded from the candidate pool. Secondary structure for each candidate sequence was then predicted using the mfold algorithm (see M. Zuker, Nucleic Acids Res. 31 (13), 3406-15, (2003)). Candidate sequences having a predicted secondary structure including a hairpin loop were discarded from the candidate pool. Tm for each candidate sequence was then predicted using a nearest neighbor algorithm, assuming salt concentrations between 1×10⁻⁸ M and 1×10⁻¹² M. Candidate sequences having a predicted Tₘ of less than about 70° C., and greater than 95° C. were then discarded from the candidate pool.

The pool of sequences remaining was then screened for predicted thermodynamic characteristics. Specifically, candidate sequences were screened for hybridization potentials against the NCBI's nt dataset. Those candidate sequences having an estimated hybridization potential with any sequence in the nt dataset of greater than or equal to −10 kcal/mol were discarded. The remaining candidate sequence pool included the following finalist sequences:

| | | |
|---|---|---|
| 1 | TATCCTACTA TACGTATCAC ATAGCGTTCC GTATGTGGCC GGGATAGACC | (SEQ ID NO: 1) |
| 51 | TAGCTTAAGC | |
| 1 | TAAGGAGTCC ACGAGTCTCA TAGAGTCGAG TGACCCGAGC TACACTACGG | (SEQ ID NO: 2) |
| 51 | TATCATAGCT | |
| 1 | CTCTCGCCCT TGTATCGTAG ACTACGTGGC TATATGATAT CGTACGAGTC | (SEQ ID NO: 3) |
| 51 | CCCTCTATCC | |
| 1 | ACTCAAATAC GGCCGATCTC CGTAGTAAGG CATCCAACCT GCGATACTAG | (SEQ ID NO: 4) |
| 51 | CCACTTCCCG | |
| 1 | ACAGCCAACT AATCCGGGAT ACCGCCGTTA TTCGACTAAT CCCGGGACGT | (SEQ ID NO: 5) |
| 51 | CAAGTTCCAC | |
| 1 | ATACGCTAGC AGCTAGGGAC GTAACTATGC ATCCCGTAAG ACGTCAACGG | (SEQ ID NO: 6) |
| 51 | TAGAGCCTTC | |
| 1 | CCGCGCGGCA TGAAGTATGC AGCGCTCGAG CCTAGTCATT CGTAAGCGAT | (SEQ ID NO: 7) |
| 51 | ATGTTTAGTG | |
| 1 | CGTTTCTACG CGTACGCCTT TATGTCGAGG CAACGCCTCG GTGTACTCCT | (SEQ ID NO: 8) |
| 51 | ACGGGTTTTG | |
| 1 | ACTGATTGCC GTGTATTAGC CGGTCGGTAA CTCGGTTCCG CTACTAGCGC | (SEQ ID NO: 9) |
| 51 | GCCAGATTTC | |
| 1 | CTAACGGGTC CAAGACGCGC AACATTATGT AGCGTACTAG GACCCTAACT | (SEQ ID NO: 10) |
| 51 | GCGACTATCC | |
| 1 | GTGCGTACCT CTATTCTACC CGGGGGTAAC GAGTTATACC CGTCCGGTGC | (SEQ ID NO: 11) |
| 51 | TAGCCTACGT | |
| 1 | CCATAAGGCG GACCCAGATC GATTGACGGG TGGCTAGATA TGTCGTGCTT | (SEQ ID NO: 12) |
| 51 | AGTTCCCAAA | |
| 1 | AGTATGTGTA GCGAGGAGCT AGTCGTCGGT GCACAATCGG CCTAGAATTA | (SEQ ID NO: 13) |
| 51 | GTTGCCTCGA | |

It will be appreciated that, although the embodiment described in the examples above is directed to nucleotide sequences for use in an array for analyzing samples containing nucleotide sequences, embodiments may also be used with array systems for analyzing samples containing other types of components such as polypeptides.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the term “configured” describes a system, apparatus, or other structure that is constructed or configured to perform a particular task or adopt a particular configuration to. The phrase “configured” can be used interchangeably with other similar phrases such as arranged and configured, constructed and arranged, adapted, constructed, manufactured and arranged, and the like.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method for generating a negative control probe sequence comprising:
randomly generating a plurality of candidate probe sequences;
screening the candidate probe sequences for sequence similarity to biologically occurring sequences; and
screening the candidate probe sequences for one or more of base composition properties, primary structural features, secondary structural features, or thermodynamic characteristics.

2. The method of claim 1, comprising screening the candidate probe sequences for base composition properties.

3. The method of claim 1, comprising screening the candidate probe sequences for primary structural features.

4. The method of claim 1, wherein screening the candidate probe sequences for primary structural features comprises eliminating the candidate negative control probes that have homopolymeric runs longer than five bases.

5. The method of claim 1, comprising screening the candidate probe sequences for secondary structural features.

6. The method of claim 1, wherein screening the candidate probe sequences for secondary structural features comprises eliminating the candidate probe sequences that form hairpin loop structures.

7. The method of claim 1, comprising screening the candidate probe sequences for thermodynamic characteristics.

8. The method of claim 7, wherein screening the candidate probe sequences for thermodynamic characteristics comprises eliminating candidate negative control probes having a Gibbs free energy hybridization potential (ΔG) to any biologically occurring sequence of a magnitude greater than or equal to −5 kcal/mol.

9. The method of claim 7, wherein screening the candidate probe sequences for thermodynamic characteristics comprises eliminating candidate probe sequences having a Gibbs free energy hybridization potential (ΔG) to any biologically occurring sequence of a magnitude greater than or equal to −10 kcal/mol.

10. The method of claim 7, wherein screening the candidate probe sequences for thermodynamic characteristics comprises eliminating candidate probe sequences having a melting temperature (Tm) of less than about 60° C. and eliminating candidate probe sequences having a melting temperature (Tm) of greater than about 105° C.

11. The method of claim 7, wherein screening the candidate probe sequences for thermodynamic characteristics comprises eliminating candidate probe sequences having a melting temperature (Tm) of less than about 70° C. and eliminating candidate probe sequences having a melting temperature (Tm) of greater than about 95° C.

12. The method of claim 1, comprising selecting candidate probe sequences that are biologically available.

13. The method of claim 1, wherein screening the candidate probe sequences for sequence similarity to biologically occurring sequences comprises screening the candidate probe sequences against databases of known biological sequences.

14. The method of claim 7, wherein the databases of known biological sequences comprise genomic sequence data.

15. The method of claim 7, wherein the databases of known biological sequences comprise expressed sequence data.

16. The method of claim 1, comprising generating a plurality of negative control probe sequences.

17. The method of claim 1, wherein the negative control probe sequences having a sequence length of 5 to 150 bases.

18. The method of claim 1, wherein the negative control probe sequences having a sequence length of 60 bases.

19. The method of claim 1, wherein the steps are performed by a computer system.

20. A computer-readable medium having computer-executable instructions for performing the steps recited in claim 1.

21. An apparatus for generating a negative control sequence for an array, the apparatus comprising:
a memory store; and
a programmable circuit in electrical communication with the memory store, the programmable circuit programmed to
randomly generate a plurality of candidate probe sequences;
screen the candidate probe sequences for sequence similarity to biologically occurring sequences; and
screen the candidate probe sequences for one or more of base composition properties, primary structural features, secondary structural features, or thermodynamic characteristics.

22. The apparatus of claim 21, further comprising an array printer, the printer responsive to the programmable circuit.

23. An isolated nucleotide sequence comprising the sequence of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, or SEQ ID NO: 13.

24. An isolated nucleotide sequence comprising a sequence complementary to that of SEQ ID NO: 1, SEQ ID NO: 2, SEQ ID NO: 3, SEQ ID NO: 4, SEQ ID NO: 5, SEQ ID NO: 6, SEQ. ID NO: 7, SEQ ID NO: 8, SEQ ID NO: 9, SEQ ID NO: 10, SEQ ID NO: 11, SEQ ID NO: 12, or SEQ ID NO: 13.


SEQUENCE LISTING (13 sequences)

SEQ ID NO: 1 - DNA, 60 bp, Artificial Sequence
  Example of negative control probes
tatcctactatacgtatcacatagcgttccgtatgtggccgggatagacctagcttaagc

SEQ ID NO: 2 - DNA, 60 bp, Artificial Sequence
  Example of negative control probes
taaggagtccacgagtctcatagagtcgagtgacccgagctacactacggtatcatagct

SEQ ID NO: 3 - DNA, 60 bp, Artificial Sequence
  Example of negative control probes
ctctcgcccttgtatcgtagactacgtggctatatgatatcgtacgagtcccctctatcc

SEQ ID NO: 4 - DNA, 60 bp, Artificial Sequence
  Example of negative control probes
actcaaatacggccgatctccgtagtaaggcatccaacctgcgatactagccacttcccg

SEQ ID NO: 5 - DNA, 60 bp, Artificial Sequence
  Example of negative control probes
acagccaactaatccgggataccgccgttattcgactaatcccgggacgtcaagttccac

SEQ ID NO: 6 - DNA, 60 bp, Artificial Sequence
  Example of negative control probes
atacgctagcagctagggacgtaactatgcatcccgtaagacgtcaacggtagagccttc

SEQ ID NO: 7 - DNA, 60 bp, Artificial Sequence
  Example of negative control probes
ccgcgcggcatgaagtatgcagcgctcgagcctagtcattcgtaagcgatatgtttagtg

SEQ ID NO: 8 - DNA, 60 bp, Artificial Sequence
  Example of negative control probes
cgtttctacgcgtacgcctttatgtcgaggcaacgcctcggtgtactcctacgggttttg

SEQ ID NO: 9 - DNA, 60 bp, Artificial Sequence
  Example of negative control probes
actgattgccgtgtattagccggtcggtaactcggttccgctactagcgcgccagatttc

SEQ ID NO: 10 - DNA, 60 bp, Artificial Sequence
  Example of negative control probes
ctaacgggtccaagacgcgcaacattatgtagcgtactaggaccctaactgcgactatcc

SEQ ID NO: 11 - DNA, 60 bp, Artificial Sequence
  Example of negative control probes
gtgcgtacctctattctacccgggggtaacgagttatacccgtccggtgctagcctacgt

SEQ ID NO: 12 - DNA, 60 bp, Artificial Sequence
  Example of negative control probes
ccataaggcggacccagatcgattgacgggtggctagatatgtcgtgcttagttcccaaa

SEQ ID NO: 13 - DNA, 60 bp, Artificial Sequence
  Example of negative control probes
agtatgtgtagcgaggagctagtcgtcggtgcacaatcggcctagaattagttgcctcga